(19) United States
(12) Patent Application Publication
(10) Pub. No.: US 2007/0265719 A1
(43) Pub. Date: Nov. 15, 2007

(54) HANDHELD RACQUET SPORTS SCORING DEVICE WITH BUILT IN LOGIC AND TECHNOLOGY TO TRACK POINTS, GAMES AND MATCHES WITH THE ABILITY TO DISPLAY SCORES ON A WALL MOUNTED SCREEN

(75) Inventors: Bryce W. Harding, Arlington, VA (US); Balamurugan Sundaralingam, Herndon, VA (US)

Correspondence Address: SUGHRUE MION, PLLC, 2100 PENNSYLVANIA AVENUE, N.W., SUITE 800, WASHINGTON, DC, 20037, US

(73) Assignee: eSportech Incorporated, Arlington, VA (US)

(21) Appl. No.: 11/381,009

(22) Filed: May 1, 2006

(51) Int. Cl. G06F 19/00

(52) U.S. Cl. 700/92

(57) ABSTRACT

A handheld electronic unit is for marking and scoring a game of squash rackets, racquetball, badminton and table tennis (both singles and doubles and inclusive of their particular variations of scoring) by an observer (the Marker/Referee) watching the game from outside of the court or field of play. It improves/standardizes scoring during matches. The device guides the user through starting and setting up a match, entering in player information, and requires minimal user input while scoring a match. Player information and statistics as well as match results are stored automatically into a database on the device, which can be linked to a computer to upload and download the information. Additionally, the device can be linked to a wall mounted display unit that allows spectators and players to view the score and match results as the game progresses The device itself is a modular system with a graphic LCD screen, buttons, a speaker, an internal processor, batteries, an enclosure, and an interface for synchronizing data with a server. Each self-contained, stand-alone system only requires the user to recharge the batteries.

### BACKGROUND OF THE INVENTION

1. Field of the Invention

This invention relates to sport scoring in general, but with an emphasis on the racquet sports of squash rackets, racquetball, badminton and table tennis. In particular, the invention relates to scoring of sports with a built in logic based on the specific sport with the ability to present the score on the Device itself and/or concurrently on a wall-mounted unit for display to the spectators. The invention may be embodied in a computer chip enabling a marker (any scoring personnel) to easily score a match and be able to interpret the score with minimal effort through the internal logic and use of simple push-buttons.

2. Related Efforts

Many sports have scoring methods and techniques with a particular scoring logic that is unique to the sport.

A number of sports in the present use manual methods of scoring where the marker keeps track of the score by writing the score down on a score sheet on a paper as the game is played. This is prone to errors and, particularly in certain of the above-identified racquet sports, corrections are periodically required and these corrections disrupt the game for periods of time, causing disruption to the game until the marker makes the correction(s) and provides resolution. The user community has found this to be very archaic and is looking for means to improve the speed, accuracy and consistency of game and match scoring.

Another technique used in scoring is the scoring through a panel, attached to the marker's chair, which displays the score on a display panel. This is once again dependent on the marker who understands the rules of the game.

Both of these prior approaches are disadvantageous. The players and the spectators viewing the game do not like to see the game disrupted when there is an error and everyone would prefer that the referee concentrates on making correct calls versus spending their effort on just getting the score correct.

Once the game is over, the data gathered on the paper is sometimes keyed into a database used to track the results and feed ranking of the players. This once again leaves room for errors and corrections.

An automated scoring Device with built in logic and rules is needed so as to provide the ease for the marker to score the game effectively and efficiently with the press of buttons so the score is captured accurately and efficiently.

The capturing of the scores and the ability to store the scores in a standardized fashion is needed so as to lead to better data gathering and analysis for ranking, performance improvement of the players and mining of data for match, game, score and rules changes and improvements.

In the current environment of sports, there are five disadvantages to the current scoring culture which are: a. inefficiency in scoring, b. incorrect scoring, c. lack of standard data recoding process, d. lack of data upload capability for analysis and rankings, e. inability to display the score for the players and spectators.

What is needed is a device designed to increase efficiency in the scoring of a game by incorporating the various scoring logic. This also would provide consistency of the data collected, for later data analysis, for the ability to display the scores on a wall mounted unit for display to the spectators of the game and capture the history of data to be uploaded to a database for global use for ranking of the players.

### SUMMARY OF THE INVENTION

An object of this invention is to fulfill the above long felt but unfulfilled needs by providing a Device that is flexible, accurate and consistent with the rules of the particular sport.

Another object of the invention, among others that will become apparent from the discussion below, is to bring a new level of accuracy and consistency to racquets sports games and tournaments. In one embodiment of the invention, while marking a game, a user is required only to press large and ergonomically located buttons, thereby minimizing the amount of distraction from observing the game (as is the case with traditional marking). This results in a higher level of accuracy since the user will be able to keep their attention focused on the game and will not be interrupted by the process of scoring. In another embodiment of the invention, the Device prompts the user with the appropriate questions to ask the players when a decision is required, ensuring that matches are conducted consistently.

The Device, according to an embodiment of the invention, provides a hand held piece of equipment that is easily portable by the players and Markers of the sport. The Device has a standard possessing logic built into a computer chip that is part of the Device.

As part of the invention, the data within the Device has standard formats and any game being scored will capture data in the similar format so the standardization of data can be utilized later during the data upload process for analysis and data mining.

The Device also provides the ability to display the scores on a wall mounted display unit that will be convenient to the spectators and players while the game is in progress.

The Device stores a history of the scores as they progress so at the end of the match, the scores can be uploaded to a database so data analysis and data mining can be conducted for ranking and monitoring the performance of the players.

### BRIEF DESCRIPTION OF THE DRAWINGS

The drawing figures depict, in highly simplified schematic form, embodiments reflecting the principles of the invention. Many items and details that will be readily understood by one familiar with the field have been omitted so as to avoid obscuring the invention. In the diagrams:

FIG. 1 is a highly simplified schematic diagram showing one embodiment of the invention.

FIG. 2 shows a more detailed view of one of the components of the decision logic used for a particular sport (squash).

FIG. 3 shows the schematic of the Device in a more generic form. The picture is a representation of the components involved in the Device and not the actual design of the Device itself.

FIG. 4 is an example of Splash screen according to an embodiment of the invention.

FIG. 5 is an example of a splash screen with menu items to choose from to navigate to other functions according to an embodiment of the invention.

FIG. 6 is an example of Device Options which can be updated for the device to be configured during the start up according to an embodiment of the invention.

FIG. 7 is an example of an Alpha Numeric Entry Screen to key in the players name and membership IDs according to an embodiment of the invention.

FIG. 8 and FIG. 9 are examples of Screen to review the player information to choose from to use for the scoring process according to an embodiment of the invention.

FIG. 10 is an example of a Player Review Screen to review how many matches has been won or lost and what the winning percentage of this player is according to an embodiment of the invention.

FIG. 11 is an example of a Match Review Screen to view the history according to an embodiment of the invention.

FIG. 12 is an example of Match Summary Screen to view the final scores of a particular match according to an embodiment of the invention.

FIG. 13 is an example of a Match Option screen to select the type of match and Game according to an embodiment of the invention.

FIG. 14 and FIG. 15 are examples of Game Decision Screen to finalize the serving team before the match starts according to an embodiment of the invention.

FIG. 16 is an example of a Game Start Screen to decide on the Serving sides and game scores according to an embodiment of the invention.

FIG. 17 is an example of Interval Screen between matches when the players take a break according to an embodiment of the invention.

FIG. 18 is an example of a Termination Confirmation of the Current Match Screen according to an embodiment of the invention.

FIG. 19 is a highly simplified schematic of the invention connected to a wall mounted display device, which can be viewed by the game spectators, connected through hardwire according to an embodiment of the invention.

FIG. 20 is a highly simplified schematic of the invention to relay the scores and the screen through a wireless media to a wall mounted display device according to an embodiment of the invention.

FIG. 21 is a highly simplified schematic of the invention highlighting the upload and capture of the scoring current and history data in a local database and be able to be accessible by other players using the invention device to retrieve or sync up data in a global database according to an embodiment of the invention.

### DETAILED DESCRIPTION

The details of the invention will now be qualified using various exemplary embodiments. Although the embodiments are described in detail, it will be appreciated that the invention is not limited to just these embodiments, but has a scope that is significantly broader. The appended claims should be consulted to determine the true scope of the invention.

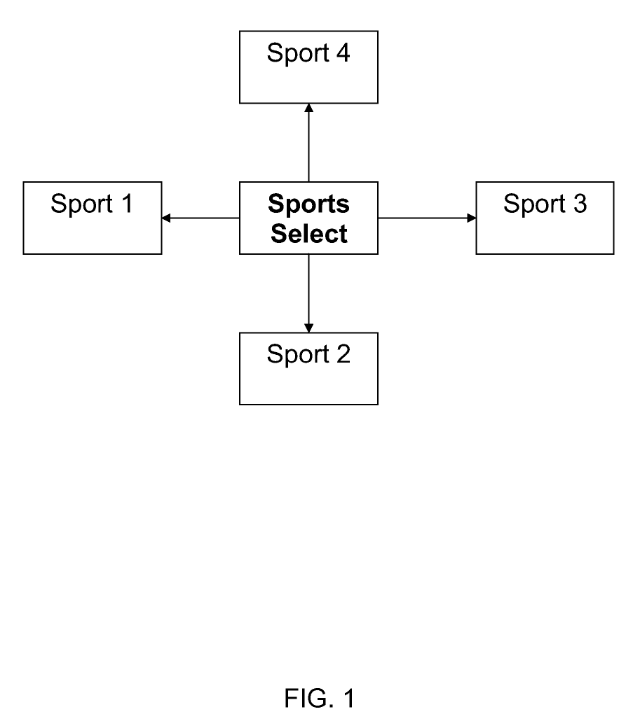

FIG. 1 shows an embodiment of the invention. It indicates the narrowing down on a particular sport to track the logic and scoring process.

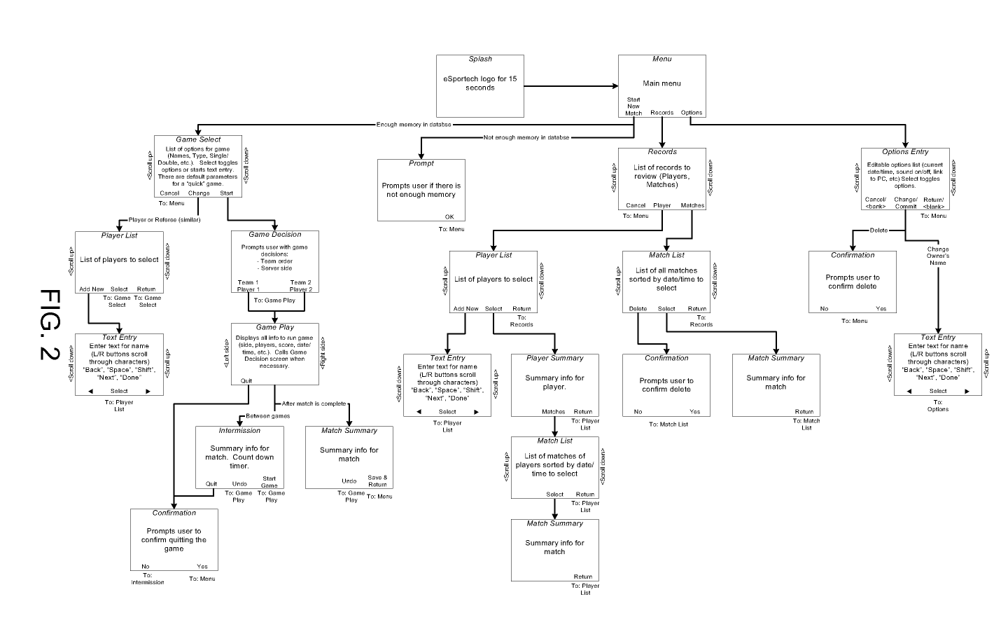

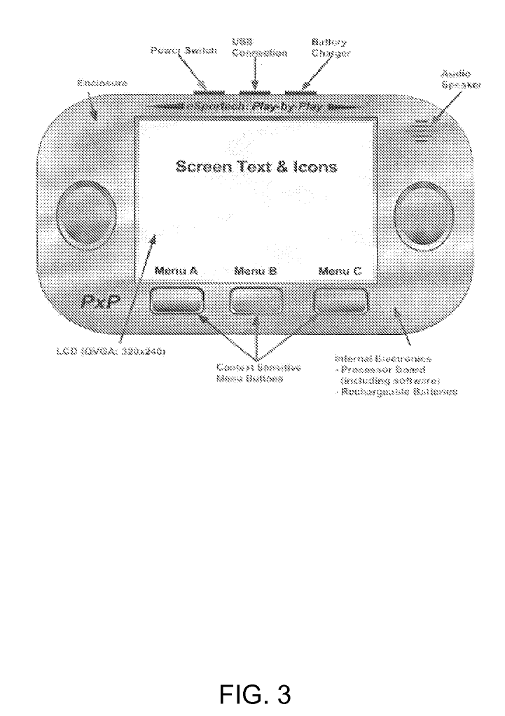

The scoring logic flow for squash rackets in the context of this embodiment will be clearer with the discussion of FIG. 2, further below. FIG. 3 is a pictorial representation of the Device, but only for ease of understanding and does not exclude variations on the graphical representation to include button style, casing shape, layout, relative size and shape. Furthermore, it will be appreciated that the term, “buttons”, as used herein, is meant not in the limitative sense, but should be understood also to include levers, pressure-sensitive areas, joysticks, and the like, as well as software-type buttons displayed on a screen, or other interaction systems known now or developed in the future. It will be understood that any kind of the foregoing ways to input commands to the internal processor may be generally thought of as means for interacting with the internal processor.

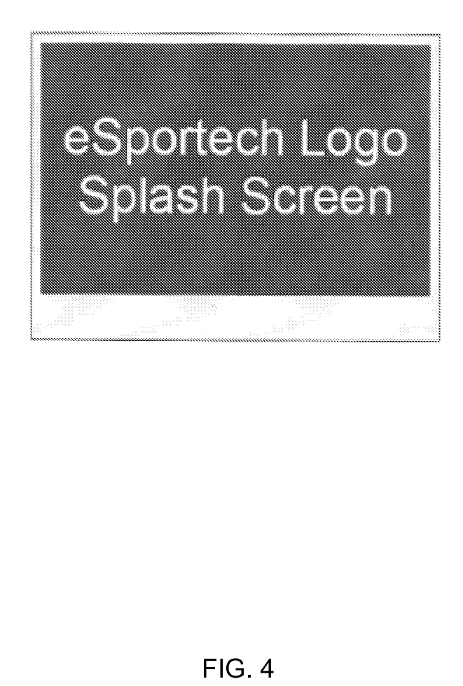

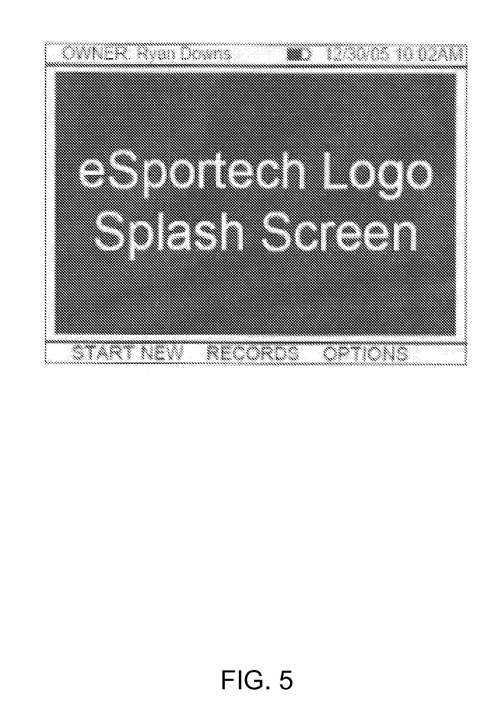

The logical flow of the operations of the Device starts with the splash screen FIG. 4—Main Splash Screen that displays the company logo and affiliations for a few seconds and goes to the FIG. 5—Main Splash Screen that is the start of the scoring options.

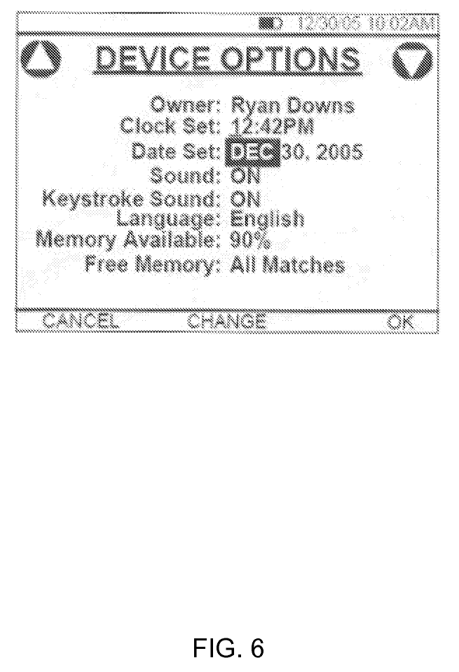

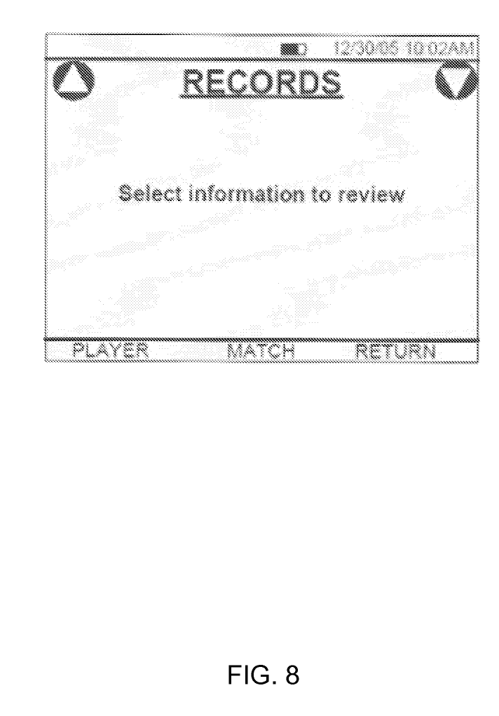

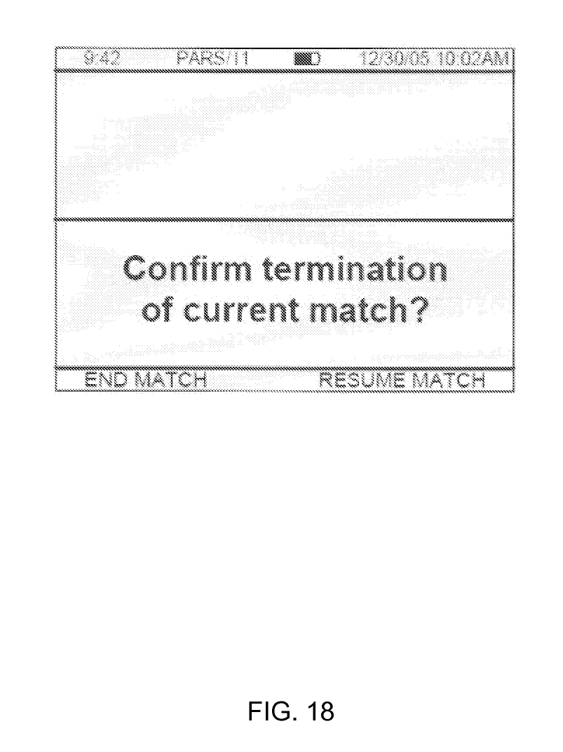

The FIG. 5—Main Splash Screen contains useful information such as name of the owner of the scoring Device. Battery life indicator, current date and time and options to chose from such, displayed as Device Options FIG. 6 to be set up or changed, Records FIG. 8 which can be viewed and selections made accordingly and to initiate a new game FIG. 18 which takes the marker to the screen to start the options for a new game

The Options Entry Screen FIG. 6 allows a number of editable options such as the ability to enter in a Device user name, the date and time. This screen also allows the user to switch on or off the audio sound for each press of the button and other Device options. This screen provides the option to choose the language (English, German, Spanish, French, Italian, but is not limited to these alone) in which to score the matches and option to view the memory usage and option to free up memory options. For each of the options heading the user has an option to cancel, change or accept their selected options.

For any changes that need to be initiated by the user in the Device options screen FIG. 6, when change are chosen as an option, the Device prompts for a confirmation before a change is effected especially when a delete is to be effected so the user can confirm by selecting a “yes or a no” confirmation.

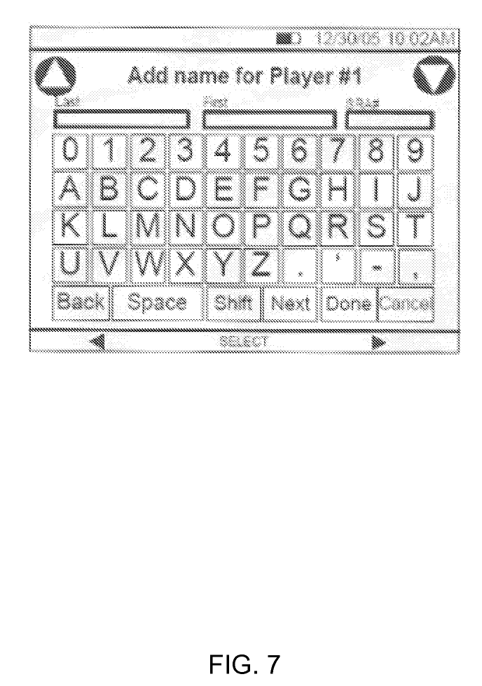

When a user name is to be changed as part of the Device options screen FIG. 6; the Device takes the user to a Text Entry Screen FIG. 7 where the user has the option to select letters or numbers to enter their last name and first name along with an ID number which could be assigned by the national or international governing bodies to players.

The Scoring Device also prompts the user when the Device does not have enough memory space (FIG. 6) so as to provide the user an option to increase memory space.

The user of the Device from the main menu screen (FIG. 5) can move towards reviewing the Records which will take the user to the Records screen FIG. 8 where the existing player records can be retrieved and viewed or can take to the matches screen where the list of matches can be viewed.

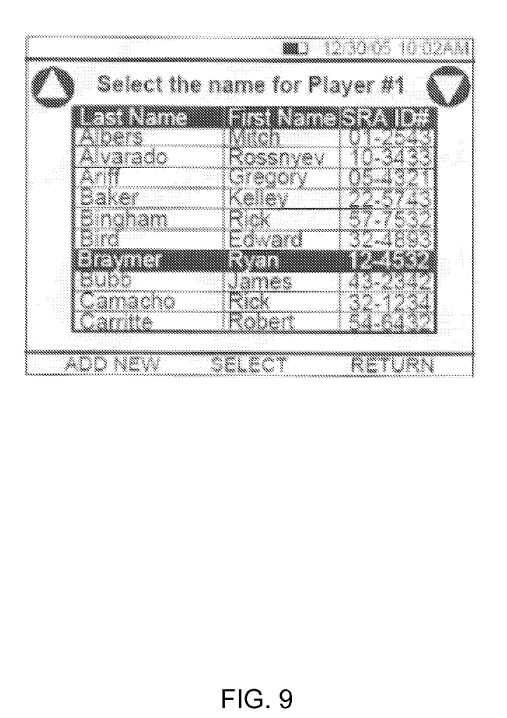

When viewing the players records, the Option from the records screen takes the user to the player list Screen FIG. 9 and if a new player need to be added to the list, the user of the Device has an option to enter in a new user details through the Text Entry Screen FIG. 7 to be added to the database.

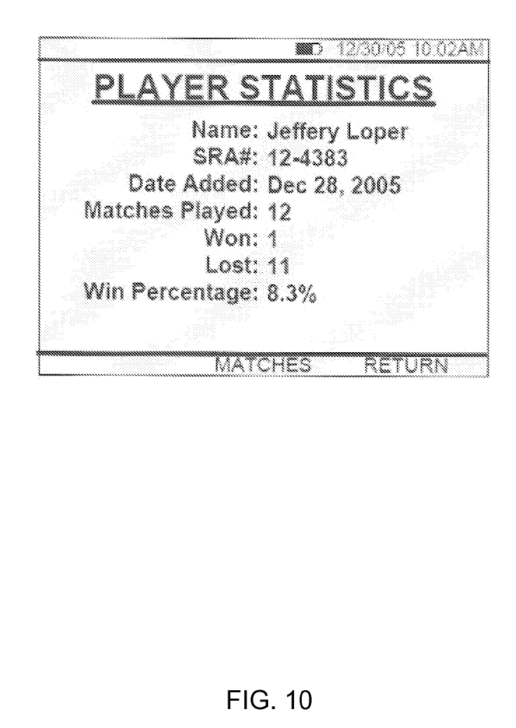

When the user of the Device selects the Player from the Player List screen FIG. 9 the user can view the details of the player FIG. 10 which provides details such as Player name, Player ID, Date a player was added to the Device, matches played using this scoring Device, games won and games lost contained on the particular Device.

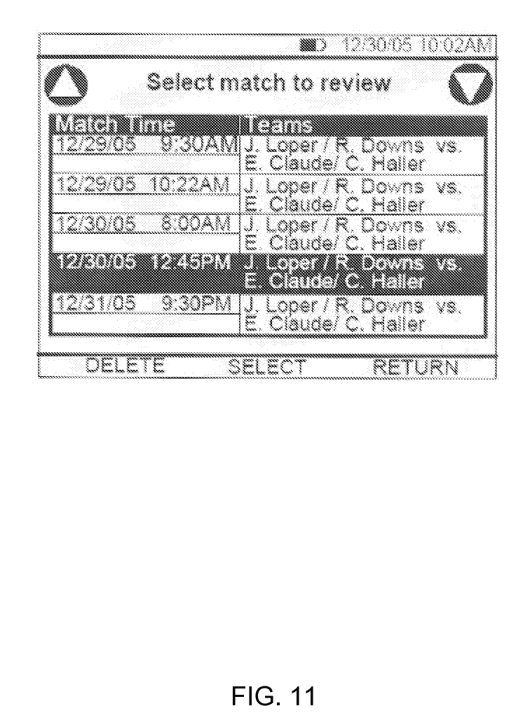

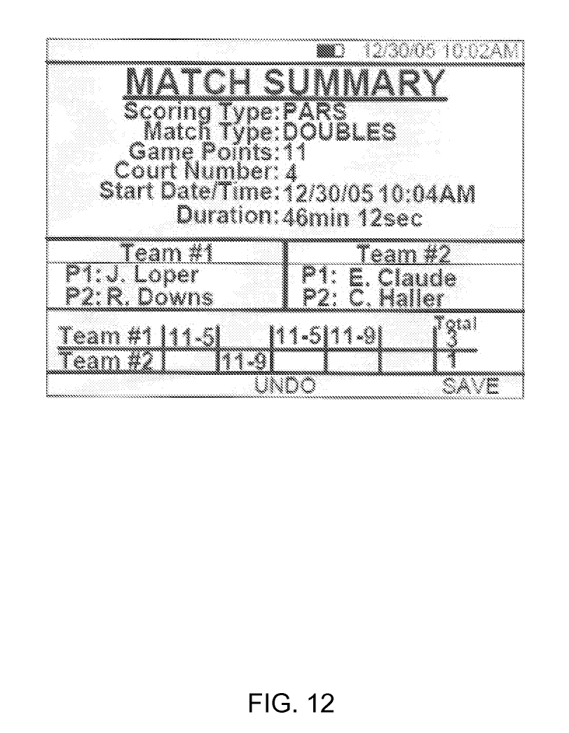

From the player detail screen FIG. 10, the user can navigate to the Matches Played screen FIG. 11 which will display all matches played by the player. A particular match can be selected from this screen and can be navigated to a match summary screen FIG. 12.

The Match Summary screen FIG. 12 provides relevant information to the match which includes Match Scoring type, Match type if its doubles or singles, game points, court number, start date and time of the match and the duration of the match. This screen also provides the details of the teams and the final scores for each match if a doubles match was played.

If the user of the Device wants to delete a match, the user can choose to do so using the screen in FIG. 11.

The match screen can be navigated directly from the Records screen FIG. 8 as well, which is an option, provided by the Device. This will enable the user to sort or research matches and view details regarding a specific match.

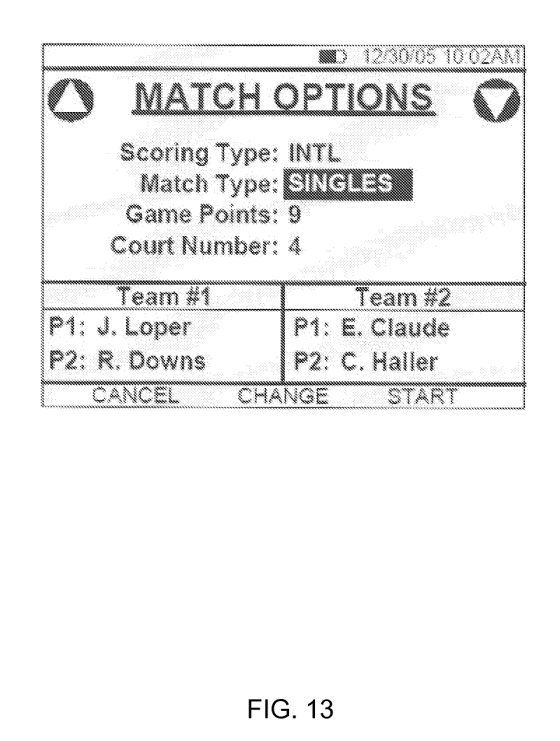

Once the user has decided to proceed with a new match, the user of the Device can navigate to the Game Option Screen FIG. 13 which allows the user of the scoring Device to select Options for the match such as Match Type, Game Points, Court Number, Teams and members of each team. The members of the team can be selected through the player list screen FIG. 9 and if needed a new player can be added to the list through the screen FIG. 7.

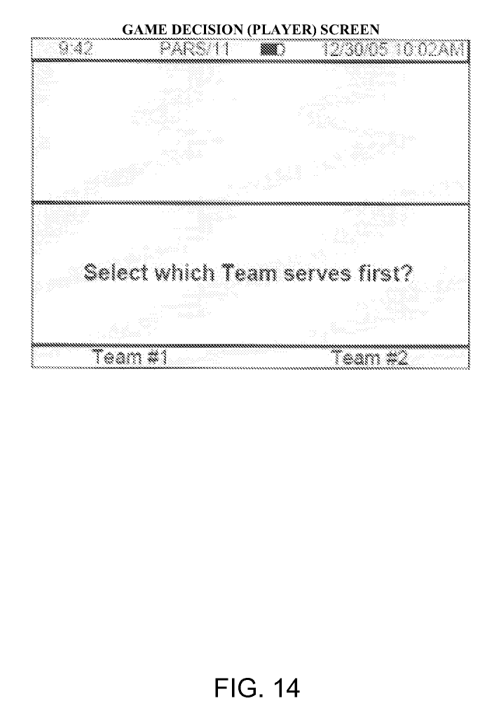

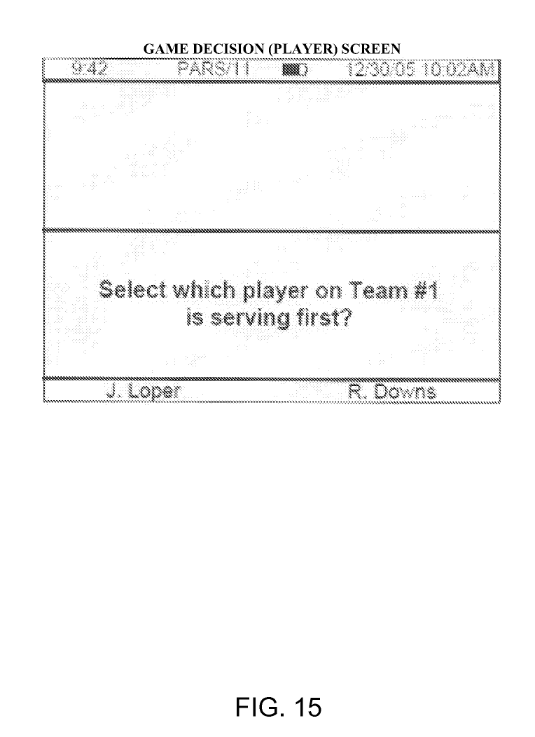

Once the match is ready to be played, the Device provides an option to select the serving side FIG. 14 and for the doubles match to select the order of player to serve FIG. 15 from the serving team.

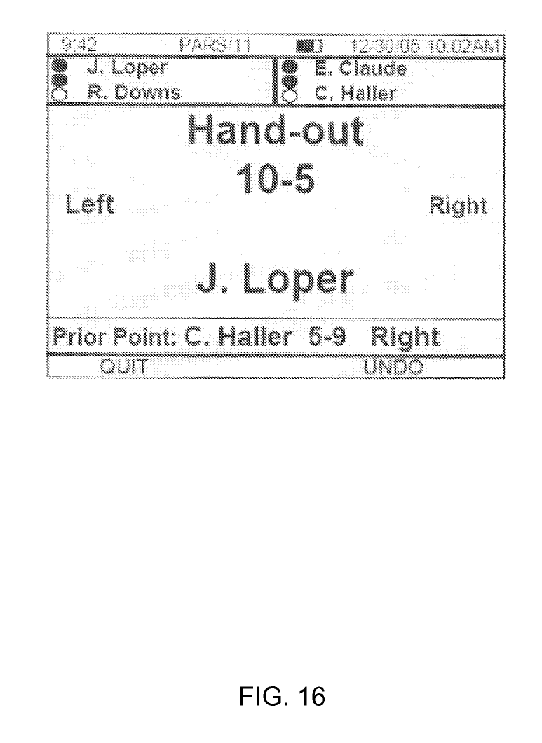

From this point forward, the game play and capturing of scores can be carried out using the Game Play Screen FIG. 16. Game points can be chosen from different screen and the match points can be selected by the press of buttons to select the serving side and the cumulative points.

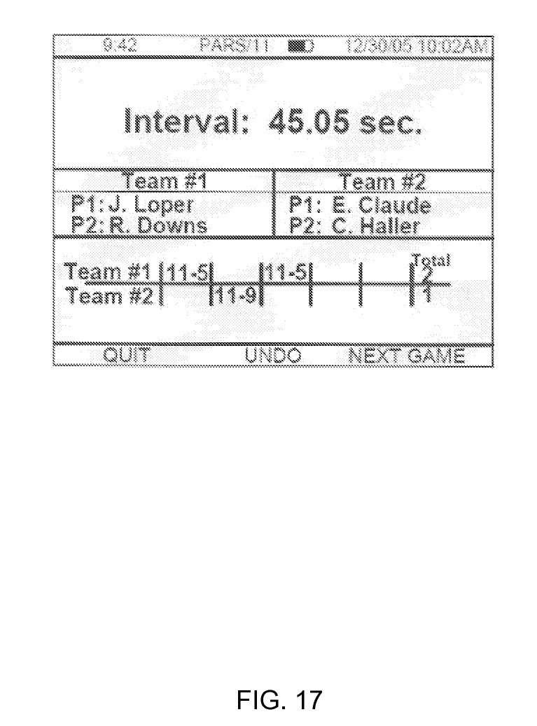

During the intervals in between the game, the Device provides the user with a timer to monitor the interval time FIG. 17

If a players decide to terminate the match for unforeseen situations, they have an option to terminate the match FIG. 18

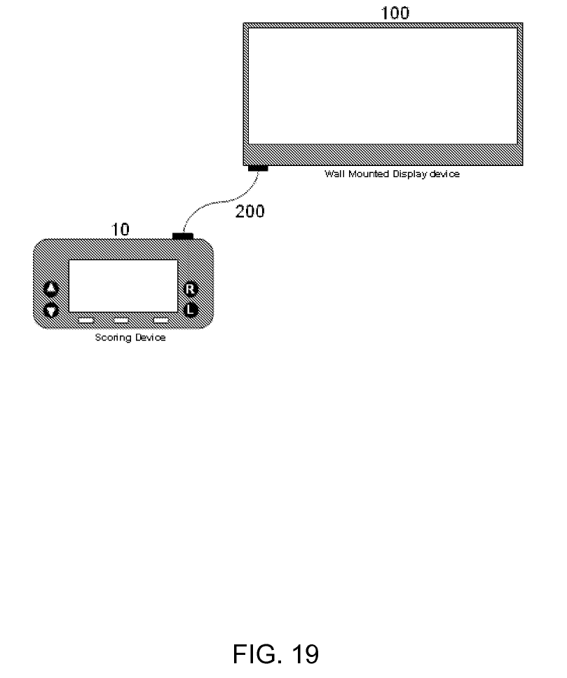

As the scoring Device is operated to capture scores, the scores from the Handheld scoring device (10) can be displayed on a wall mounted unit (100) connected through a hard wire (200) so the spectators can view the score while the game is in progress. (FIG. 19)

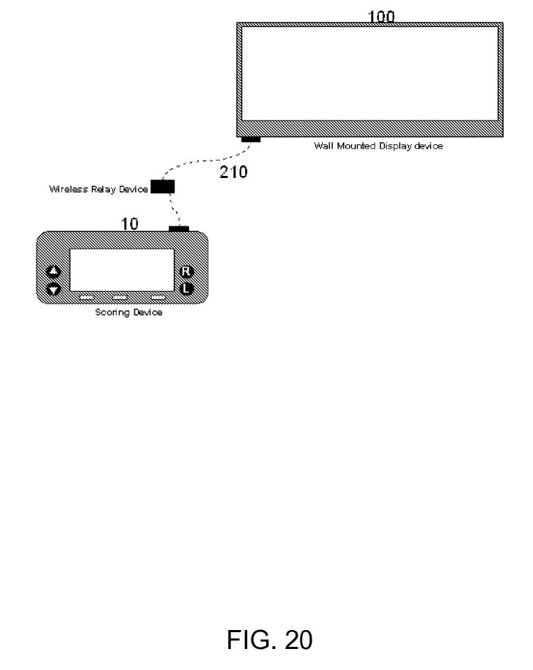

Another option for displaying the scores from the Handheld Scoring Device (10) to the wall mounted display unit (100) can be through an infrared rays using wireless connectivity (210) so the spectators can view the score while the game is in progress (FIG. 20)

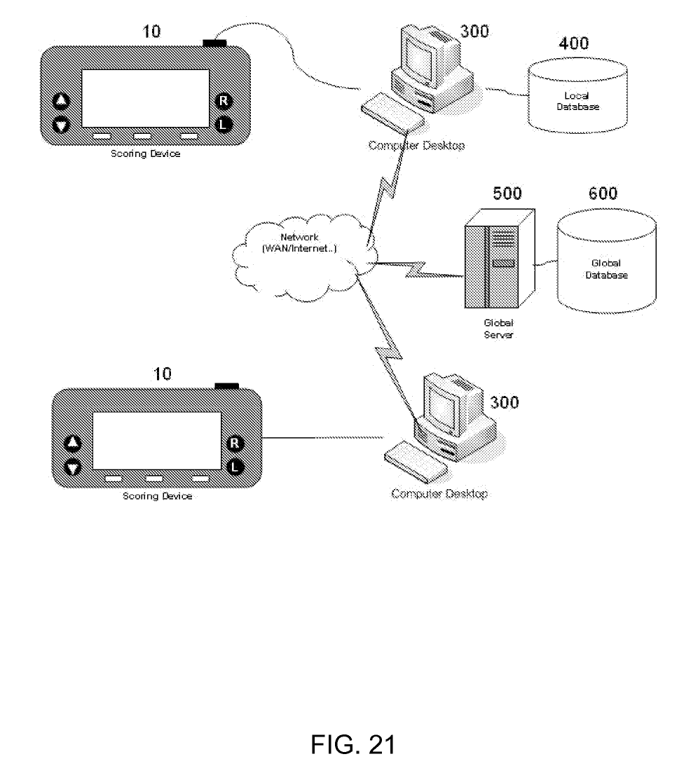

Once the data is captured through the scoring Device (10), the standard set of data can be uploaded to a local database (400) by connecting the device to a Desktop Computer (300). For the sake of example, and not by way of limitation, it will be appreciated that the database may be a relational database management system (RDBMS) such as an ORACLE RDBMS, a SYBASE RDBMS, a MICROSOFT ACCESS RDBMS, or any RDBMS available from any other vendor. A custom database management system may also be used in this case. The Local database can also upload the data through a network to a Global Server (500) and stored in a Global database so that a user can access the data and use them for ranking purposes or any analytical purposes through another desktop (FIG. 21)

The Device in FIG. 3 is more of a representation that shows the schematic of the Device in a more generic form. The picture is a representation of the components involved in the Device and not the actual design of the Device itself.

The Device contains internal electronics, a processor board, software, audio speakers, and rechargeable batteries. The electronics are for controlling LCD, interface to buttons and power switch, driving audio, and controlling recharge rate and level indication of the battery life.

The Device complies with the appropriate industry standards (such as CE, UL) for safety and emissions. The initial prototype is not required to conform to the standards.

The Device provides the ability to score a game in real-time by user interaction. The Device provides the ability to enter, view, and manage data related to the game, players, and Device specific information (such as owner name, or unique Device identification) so as to support the overall requirements. The Device includes static memory to hold up to a minimum of the combination of 100 players and 100 games, but can hold more or less depending on the specific sport being scored. The Device provides the ability to score multiple types of squash rackets games (International/Point-a-Rally), multiple players (Single/Doubles), and different game points (9, 11, 15) and similar variations for the other aforementioned racquet sports.

The architecture of the Device electronics, processor boards, etc., is designed to support the software requirements described below.

The Device includes an internal, rechargeable battery that provides a minimum of 4 hours of normal operating time. Internal batteries are capable of being recharged through the battery charging connector with a supplied DC power adapter.

The Device includes electronics to control the rate of charge of the internal batteries from a plugged in external DC adapter so that the batteries are not damaged during charging.

The Device includes electronics to detect the battery voltage level into at least three levels spanning full voltage down to minimum voltage required to supply the electronics.

All battery and computer link external interfaces are designed with standard electrical connectors. Each power and computer link connector shall be unique to prevent the user from improperly connecting cables.

The Device includes a power switch to turn on and off power.

The Device includes electronics to detect button presses by the user.

The Device includes electronics to drive and control the LCD and include electronics to drive an audio speaker.

The enclosure for the Device contains the required logos and markings and other brand identifiers.

The outer dimensional envelope of the Device preferably does not exceed dimensions of 6″ L×4″ W×0.75″ D, but in the spirit of the invention may be smaller of larger depending on design changes and requirements.

The maximum weight of the Device preferably does not exceed 14 ounces including batteries, but in the spirit of the invention may be smaller of larger depending on design changes and requirements.

The enclosure for the Device may provide entry cable connections for battery charging adapter and a computer link connector (USB). Optionally, charging may be accomplished through the USB connector.

The enclosure for the Device provides mounting for buttons, a power switch, houses the electronics including processor board, LCD, batteries, connections, etc. and provides features (such as slots) to hold summary score cards on the back of the Device.

Through the LCD and buttons of the front panel display an operator has the ability to accomplish the following: view game-play, game setup and controller setup information via the LCD as outlined above, input game-play, game setup and controller setup information via buttons as above.

On-board speaker will function to support functions outlined above.

Through the USB connection on the enclosure of the Device, the operator may have the ability to: upload controller player and match data from a host PC; download controller player, match and scores to the Device.

It will be appreciated by those familiar with this field that the invention can be embodied in other specific forms without departing from the spirit or essential character thereof. The embodiments described above should be considered to be illustrative and not restrictive. The scope of the invention is indicated by the appended claims, and all changes that come within the meaning and range of equivalents thereof are intended to be embraced therein.

What is claimed is:

1. A handheld electronic scoring device, intended for use in the racquet sports of squash rackets, badminton, racquetball and table tennis, comprising:
a graphic LCD screen for display,
buttons for input,
a speaker for audible indication to the user,
an internal processor,
rechargeable batteries,
an enclosure, and
an interface for synchronizing data with an external data server,
wherein the scoring device is a self-contained, stand-alone system.

2. A scoring system including a scoring device as defined in claim 1, the device being linked to a display panel mounted outside of the playing area, the display panel displaying point, game and match scores.

3. A scoring device as defined in claim 1 that enables the user to upload the scoring data into a database that can be used for player statistics, player rankings and data mining.

4. A scoring device as defined in claim 1, further comprising a memory storing player and match data.

5. A scoring device as defined in claim 1, further comprising built-in logic for racquet sports, including the sports of squash rackets, badminton, racquetball, and table tennis, and the variations of singles and doubles.

6. A scoring device as defined in claim 1, wherein the internal processor scores a game in real-time by user interaction.

7. A scoring device as defined in claim 1, wherein the processor and display provide the ability for a user to enter, view, and manage data related to a game and players.

8. A scoring device as defined in claim 1, further comprising static memory adapted to store a combination of 100 players and 100 games.

9. A handheld electronic squash rackets scoring device, comprising:
an enclosure housing an internal processor and a graphic LCD screen under control of the internal processor;
an interface for displaying information on an external display panel, under control of the internal processor;
means for interacting with the internal processor;
an interface for synchronizing data with an external data server; and
logic, in the internal processor, for enabling a marker to score a squash rackets match;
wherein the squash rackets scoring device is a self-contained, stand-alone system.

10. A device as defined in claim 9 adapted to upload the scoring data into a player statistical database.

11. A device as defined in claim 9, further comprising a memory adapted to store player and match data.

12. A device as defined in claim 11, wherein the memory stores a data of at least 100 games, including player data.
